(19) United States
(12) Patent Application Publication
(10) Pub. No.: US 2015/0242922 A1
(43) Pub. Date: Aug. 27, 2015

(54) SYSTEMS AND METHODS FOR AUTOMATIC PRODUCT INFORMATION AT A MERCHANT LOCATION

(71) Applicant: EBAY INC., San Jose, CA (US)

(72) Inventor: Kamal Zamer, Austin, TX (US)

(21) Appl. No.: 14/189,333

(22) Filed: Feb. 25, 2014

(51) Int. Cl. G06Q 30/06; G06Q 10/08

(52) U.S. Cl. CPC G06Q 30/0623; G06Q 10/087

(57) ABSTRACT

There are provided systems and method for automatic product information at a merchant location. An image from a user at a merchant may be processed to recognize the product in the image. Inventory level information corresponding to a current inventory level of the product available at the merchant may be accessed and communicated to the user. The user may also be updated with distributor inventory information in the event that the merchant does not possess enough stock to fulfill purchase requirements of the user. Preferred distributors of a merchant may be determined so that a user may be updated with inventory levels of distributors the merchant is likely to interact with. As the user or the merchant completes purchase requests, the inventory level information of the merchant may be updated. Additionally, the inventory level information may be updated when the merchant receives deliveries from a distributor.

### TECHNICAL FIELD

The present application generally relates to automatic product information at a merchant location and more specifically to processing images from a user device to recognize a product and communicating inventory level information for the product to a user.

### BACKGROUND

Users may visit merchant locations to purchase products. However, at smaller merchant locations or with products often left for display with inventory stored elsewhere, the user may not know the amount of product available. For example, a user completing a new floor for a housing project may view a particular hardwood floor panel, but not know whether the merchant carries enough stock to complete the project. Thus, the user often must have a sales representative go to stockrooms and check, which may waste valuable time for the user and the sales representative. If the merchant finds that there is not enough inventory to meet the user's requirements, the user may forego purchasing the product. Moreover, the user may entirely forego a purchase until the quantity required is available if the user is unaware of similar products.

Additionally, users may engage in a purchase and have a specific product, however, later require more or replacement products from a merchant. The user may end up waiting long periods for products from distributors if the merchant who previously had the product does not have additional inventory. If distributors are out of a product or the product has been discontinued, the user may end up with an incomplete project. Users may look up other distributors, but if the distributor is not one the merchant normally deals with, the user may wait long periods or be required to make purchases elsewhere. This can lead to added cost, time, and effort to secure the correct products.

### BRIEF DESCRIPTION OF THE DRAWINGS

FIG. 1 is a block diagram of a networked system suitable for implementing the process described herein, according to an embodiment;

FIG. 2 is an exemplary interaction between a user device and a plurality of servers for displaying product inventory level information to a user, according to an embodiment;

FIG. 3 is an exemplary system environment showing a user retrieving product inventory level information from a merchant, according to an embodiment;

FIG. 4 is a flowchart of an exemplary process for automatic product information at a merchant location, according to an embodiment; and

FIG. 5 is a block diagram of a computer system suitable for implementing one or more components in FIG. 1, according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A user may visit a merchant location and browse the merchant location for a product. When the user locates a product for sale from the merchant at the merchant location, the user may utilize a user device, including a mobile phone, digital camera, smart device (e.g., smart watch or glasses including various image capture functions), or other device having a camera and network connection capabilities, to capture an image of the product. The image may be processed to recognize the product in the image. In various embodiments, the user device may utilize image recognition to recognize the product. However, the image may also be transmitted to a merchant device, merchant server, and/or payment provider server corresponding to the merchant that may process the image to recognize the product. The image may be transmitted to one of the aforementioned entities through a wireless connection to the merchant device, a wireless beacon connected to a device of the merchant (e.g., a Bluetooth Low Energy wireless beacon offering check-in services at the merchant location), or over a network. Once the product is recognized, an inventory level of the product with the merchant may be determined and communicated to the user. Inventory level information may be determined through the merchant device, merchant server, and/or payment provider server. In one embodiment, the payment provider server maintains current store inventory based on number of purchases of a particular item and delivery or intake of the item, such as from scanning invoices, delivery records, and the like. Thus, the user may be informed of inventory levels of products with the merchant without requiring checks with employees at the merchant location.

In addition to the inventory level information for the product available with the merchant, a distributor may also be queried for inventory level information. The distributor inventory level information may be communicated to the user so the user may determine if the desired product is available in stock elsewhere if the merchant does not possess the requisite inventory numbers. Using invoices of the merchant, postage paid to distributors by the merchant, and/or customer invoices with the merchant for products available from a distributor, a set of preferred distributors for the merchant may be determined. Inventory information for the preferred merchants may be stored so that the user may be updated with inventory levels for the product even if one of the distributors is unavailable or a repeated API call to a distributor server is undesirable. The preferred distributor inventory level information may also be utilized by the merchant to determine ordering schedules and amounts.

As purchases or purchase requests for a number of the product are made by the user, or inventory checks for a specific amount are made to the merchant, the available inventory level with the merchant may be decreased. Thus, the merchant's inventory level information may be automatically updated for future users. If the merchant receives a new supply of the product, the inventory level may be increased. Information about a new supply of the product may come from merchant and/or distributor invoices or order requests by another user. Additionally, if the merchant does not have sufficient stock to meet a user's requirements for a product, a similar item to the product with sufficient inventory may be offered to the user. Similar items may be determined through other user's purchases after querying inventory levels for the same product. Thus, the user may still make a purchase even if a first viewed item does not have sufficient inventory with the merchant.

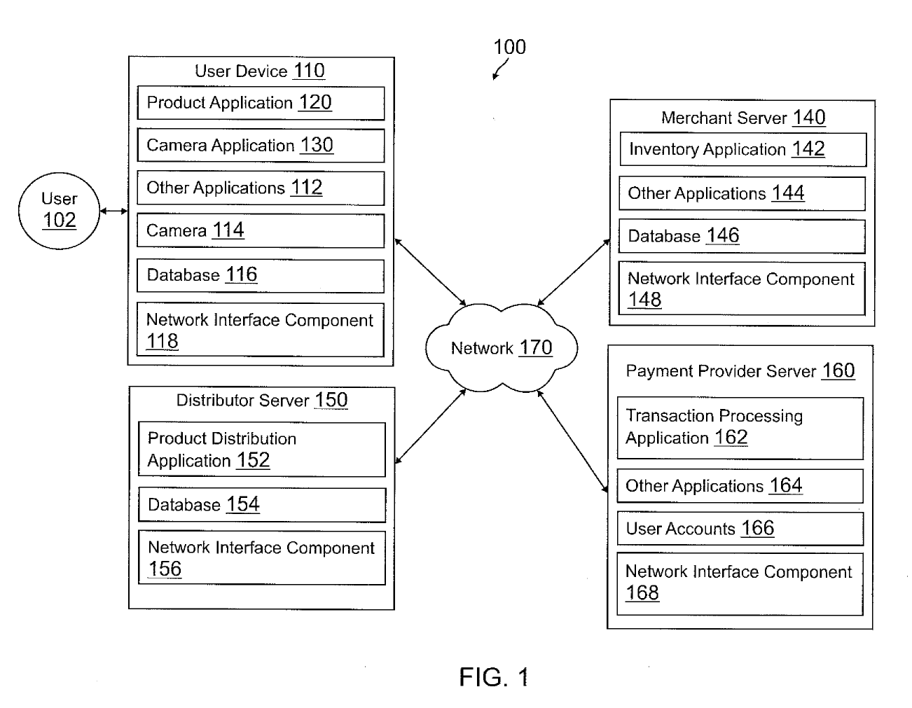

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant server 140, a distributor server 150, and a payment provider server 160 in communication over a network 170. User 102, such as a consumer, utilizes user device 110 at a merchant location corresponding to merchant server 140 to take an image of a product. Image recognition is performed on the image to determine the product. Inventory level information with the merchant may be determined from merchant server 140 and communicated to user 102 through user device 110. Additionally, distributor inventory level information may be determined from distributor server 150 and communicated to user 102 through user device 110. User 102 may also utilize payment provider server 160 to complete payments for the product.

User device 110, merchant server 140, distributor server 150, and payment provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software configured for wired and/or wireless communication over network 170. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a product application 120, a camera application 130, other applications 112, a camera 114, a database 116, and a network interface component 118. Product application 120, camera application 130, and other applications 112 may correspond to processes, procedures, and/or applications executable by a hardware processor, for example, a software program. In other embodiments, user device 110 may include additional or different software as required.

Product application 120 may be used, for example, to provide a convenient interface to permit user 102 to view products available from a merchant with product information, including inventory level information. For example, product application 120 may be implemented as an application having a user interface enabling the user to select an image, recognize the product in the image or transmit the image to another image recognition source, and receive product information including inventory level information with a merchant corresponding to merchant server 140. Additionally, product application 120 may include processes and functions to receive and display distributor inventory level information for the product from distributor server 150. In an event where a sufficient inventory amount for the product is not available with the merchant, product application 120 may include processes and functions to display similar products to user 102. The information displayed to user 102 may be received from merchant server 140, distributor server 150, and/or payment provider server 160.

Product application 120 may access an image of a product from camera application 130. In various embodiments, product application 120 may perform image analysis (e.g., image recognition) to determine a product represented in the image. Product application 120 may utilize information available in database 116 and/or over network 170 to recognize the product in the image. However, in other embodiments, product application 120 may transmit the image to another entity, such as merchant server 140 and/or payment provider server 160 for analysis and recognition of the product.

Once the product is recognized in the image, information about inventory levels of the product available with merchant server 140 and/or distributor server 150 may be determined, as will be explained in more detail here. Product application 120 may receive the inventory level information with merchant server 140 and/or distributor server 150 and present the information to user 102. The information may include specific inventory levels with a merchant that user 102 is located at and a preferred distributor of the merchant. User 102 may utilize product application 120 to browse the product inventory levels with each entity and make selections of inventory amounts of the product.

In various embodiments, user 102 may find that an available product inventory level with merchant server 140 and/or distributor server 150 is insufficient to meet user 102's requirements. Thus, product application 120 may include functionality to receive and display similar products to the product recognized in the first image. The similar products may correspond to items other purchasers bought after viewing and/or requesting an inventory level for the product recognized in the image, as will be explained in more detail here.

Product application 120 may further be utilized to enter payment options for storage by user device 110, provide payment options on checkout/payment of a product, and complete a transaction for the product. In some embodiments, product application 120 may correspond more generally to a web browser configured to view information available over the Internet or access a website corresponding to a payment service. Product application 120 may utilize user financial information, such as a credit card, bank account, or other financial account. Additionally, product application 120 may provide payment for products using a user account with payment provider, such as payment provider server 160.

Product application 120 may further be utilized to communicate with merchant server 140 and/or a merchant device at a merchant location user 102 is visiting. Product application 120 may transmit payment information and/or transaction histories and check-in with the merchant device including check-in with a wireless beacon (e.g., a Bluetooth Low Energy wireless beacon). Check-in with a wireless beacon may be accomplished using a communication module of user device 110 (e.g., network interface component 118) with the wireless beacon. The connection may be established with or without user input from user 102. For example, the wireless beacon may broadcast a token, including a universally unique identifier (UUID), for reception by product application 120. Product application 120 may receive the token from the wireless beacon. If product application 120 acknowledges the UUID as identifying the merchant, product application 120 may transmit an identifier corresponding to user 102 and/or user device 110 back to the wireless beacon. Product application 120 may communicate with the wireless beacon over near field communication, Bluetooth, Bluetooth Low Energy, radio, infrared, or other connection. The identifier from user device 110 may include, be transmitted with, concatenated with, or otherwise bundled with the identifier received from the wireless beacon. Identifiers may be transmitted as an encrypted token using public/private key(s) of user device 110 and/or the merchant. Additionally, tokens may include a received identifier from the intended recipient of the token in addition to the transmitted identifier in order to identify the token's intended recipient

Once user 102 has requested an inventory check and/or completed a purchase request for a number of the product recognized from the image with the merchant, the history may be transmitted by product application 120 to merchant server 140, distributor server 150, and/or payment provider server 160 for updating the inventory level information for the product. The inventory check and/or purchase request may correspond to a change in the inventory level with the merchant at user 102's location, all product inventory available with merchant server 140, and/or product inventory available with distributor server 150. Product application 120 may further reflect changes to the inventory levels of the product to user 102.

Camera application 130 may be configured to provide an application to capture images using a device camera of user device 110, such as camera 114. Camera application 130 may provide additionally processing after capturing an image, including cropping, adjusting color/saturation/resolution, or other editing procedures. Camera application 130 may utilize functions associated with camera 114, such as flash, zoom, image resolution, or other camera parameter. Additionally, camera application 130 may provide for creating, accessing, and editing a library of images, such as a photo library of captured images stored in database 116. The library and/or individual images may be accessible by one or more other applications, including product application 120, through an API of camera application 130. Images captured by camera 114 may correspond to still images and/or video images.

In various embodiments, product application 120 and camera application 130 may be incorporated in the same application so as to provide their respective features in one convenient application interface.

In various embodiments, user device 110 includes other applications 112 as may be desired in particular embodiments to provide features to user device 110. For example, other applications 112 may include security applications for implementing client-side security features, programmatic client applications for interfacing with appropriate application programming interfaces (APIs) over network 170, or other types of applications. Other applications 112 may also include email, texting, voice and IM applications that allow a user to send and receive emails, calls, texts, and other notifications through network 170. In various embodiments, other applications 112 may include financial applications, such as banking, online payments, money transfer, or other applications associated with payment provider server 160. Other applications 112 may include check-in applications and/or browser applications. Other applications 112 may contain software programs, executable by a processor, including a graphical user interface (GUT) configured to provide an interface to the user.

Camera 114 corresponds to an optical device of user device 110 enabling user 102 to record images, including still and/or video images. Camera 114 may correspond to a digital camera on a user device, or may more generally correspond to any device capable of recording an image. Camera 114 may include various features, such as zoom, flash, focus correction, shutter speed controls, or other various features usable to capture one or more images of user 102 and/or other users. Camera 114 may further display a preview and/or captured image to user 102 through another device of user device 110, such as a viewfinder, screen (e.g., mobile phone screen), or other display. User 102 may utilize camera 114 with camera application 130 to record a still image and/or video image containing a product available at a merchant corresponding to merchant server 140.

User device 110 may further include database 116 which may include, for example, identifiers such as operating system registry entries, cookies associated with product application 120, camera application 130, and/or other applications 112, identifiers associated with hardware of user device 110, or other appropriate identifiers, such as identifiers used for payment/user/device authentication or identification. In certain embodiments, identifiers in database 116 may be used by an account provider, such as merchant server 140, distributor server 150, and/or payment provider server 160, to associate user device 110 with a particular account maintained by the account provider. Database 116 may include images (i.e., photograph and video images) including a representation of a product available with merchant server 140 and/or distributor server 150. Database 116 may include inventory check information and/or transaction histories for purchase requests that may be utilized and/or transmitted to merchant server 140, distributor server 150, and/or payment provider server 160 for determining available inventory levels for a product.

In various embodiments, user device 110 includes at least one network interface component 118 adapted to communicate with merchant server 140, distributor server 150, and/or payment provider server 160 over network 170. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant server 140 may be maintained, for example, by a merchant or seller offering various items, products, and/or services through a merchant location. Generally, merchant server 140 may be maintained by anyone or any entity that receives money, which includes charities as well as retailers and restaurants. In this regard, merchant server 140 may include sales, payment, and/or inventory applications, which may be configured to interact with user device 110, distributor server 150, and/or payment provider server 160 to facilitate the sale of products, goods, and/or services. Additionally, merchant server 140 may include applications to facilitate inventory checks, including providing inventory level information to user 102, and updating inventory level information based on the inventory checks, sales, and deliveries of products. Merchant server 140 may correspond to a server and/or device available at a single merchant location. However, in other embodiments, merchant server 140 may correspond to a plurality of merchants and/or merchant locations.

Merchant server 140 may be implemented using any appropriate hardware and software configured for wired and/or wireless communication with user device 110, distributor server 150, and/or payment provider server 160. For example, in one embodiment, merchant server 140 may be implemented as a single or networked personal computer (PC), a smart phone, personal digital assistant (PDA), laptop computer, and/or other types of computing devices at a merchant location capable of transmitting and/or receiving data. Although a merchant server is shown, the merchant server may be managed or controlled by any suitable processing device. Although only one merchant server is shown, a plurality of merchant servers may be utilized.

Merchant server 140 includes an inventory application 142, other applications 144, a database 146, and a network interface connection 148. Inventory application 142 and other application 144 may correspond to processes, procedures, and/or applications executable by a hardware processor, for example, a software program. In other embodiments, merchant server 140 may include additional or different software as required.

Merchant server 140 includes inventory application 142, which may be configured to provide information over network 140 to user device 110, distributor server 150, and/or payment provider server 160. In various embodiments, inventory application 142 may receive product identification, complete inventory checks by providing inventory level information, and provide the inventory level information to users, including user 102. Inventory application 142 may further be configured to update inventory level information after inventory checks, purchase requests, and/or deliveries of products. Inventory application 142 may also provide similar items to a product when inventory levels of the first searched product do not have the required amount to meet the demands of user 102.

Inventory application 142 may provide inventory level information to user 102 for a product represented in an image captured by user 102. Product information may be provided to inventory application 142 after recognizing the product in the image by another source, such as user device 110, distributor server 150, and/or payment provider server 160. However, in other embodiments, inventory application 142 may receive the image of the product and perform image analysis and recognition of the product in the image. Inventory application may utilize product information, images, and/or other data in database 146 to recognize the product in the image.

Once the product information is obtained through analysis of the image, inventory application 142 may retrieve inventory level information from database 146 for the product. The inventory level information may correspond to available inventory levels for the product at a merchant location corresponding to user 102 or for all merchant locations corresponding to merchant server 140 (e.g., if merchant server 140 corresponds to a plurality of merchants/merchant locations). Inventory application 142 may communicate the information to user 102 through user device 110.

Inventory application 142 may also retrieve distributor inventory level information for inventory levels of the product available with a distributor. For example, inventory application 142 may make API calls to an application/database of distributor server 150 to retrieve inventory levels with one or more distributors corresponding to distributor server 150. Inventory application 142 may generally provide additional information to user 102 or may provide the information in response to a certain product request amount, for example, if a merchant does not possess sufficient inventory. In other embodiments, distributor inventory level information may be retrieved by one or more of user device 110 and/or payment provider server 160. Inventory application 142 may generate and/or access preferred distributor information to provide distributor level information for the preferred distributor to user 102.

After inventory checks for specific inventory levels are made, payment requests are processed, and/or additional product inventory levels are delivered to a merchant, inventory application 142 may update the product's inventory level information with merchant server 140. Thus, inventory level application 142 may keep current inventory level information for the product with merchant server 140. The current inventory level information may correspond to one merchant, each merchant of a plurality of merchants, or generally to merchant server 140 (e.g., all merchants corresponding to merchant server 140). Inventory application 142 may also be used to request product deliveries from distributor server 150. User 102 may make the request or a salesperson at a merchant location may make the request. Thus, if a merchant location does not possess sufficient inventory, inventory application 142 may request additional stock.

Inventory application 142 may further provide similar items to user 102 through user device 110 to a product recognized in an image. For example, if user 102 takes an image of a floor tile, similar floor tiles to the one recognized in the image may be provided to user 102. Similar products may be determined by a merchant, by a system administrator of merchant server 140, or through purchase analysis. Purchase analysis may correspond to purchases of a different product by a user after searching for the product recognized in the image. For example, a user may visit a merchant location and search for inventory levels for a product in an image. If the inventory levels do not meet the user's demands, the user may purchase a different product. A correlation that the product is similar may be based on this action by the user. Similar product information may be provided generally to user 102 or may be provided on a request by user 102. If a product's inventory level does not meet the demands of user 102, similar products may also be provided to user 102.

In various embodiments, merchant server 140 includes other applications 144 as may be desired in particular embodiments to provide features for merchant server 140. For example, other applications 144 may include security applications for implementing server-side security features, programmatic server applications for interfacing with appropriate application programming interfaces (APIs) over network 170, or other types of applications. Other applications 144 may contain software programs, such as a graphical user interface (GUI), executable by a processor that is configured to provide an interface to the user.

Other applications 144 may include payment applications configured to complete payment requests for products available from a merchant. Thus, other applications 144 may include further processing applications, such as invoice and/or reordering/restocking to update merchants with inventory levels, reorder stock of inventory, and update financial records. In other embodiments, payment applications may be provided by the merchant local to user 102 (e.g., the merchant location user 102 is visiting).

Other applications 144 may include check-in applications configured to associated user 102 with a merchant location user 102 is visiting. Check-in applications may associate user device 110 with a merchant device at the location and enable the communication of information, including inventory levels and purchase requests. Thus, the check-in application may correspond to server-side processes to complete check-in with user device 110. The check-in request may include login information for a user account in database 146 and thus complete the check-in with user 102 by verifying the account information. However, in embodiments where a user account has not been previously established by user 102 and/or merchant server 140 does not offer user account services, the check-in application may receive other information for identifying user 102, include user name/identifier, user device identifier, a payment account/payment account identifier with payment provider server 160, or other information. Check-in may be completed through a wireless beacon available at a merchant location, as previously discussed, or through a merchant device at the merchant location, and/or with merchant server 140.

Merchant server 140 includes database 146, which may be configured to store user account identifiers, inventory level information, product information, and/or uploaded user images. Product information may include product identifiers, product prices, and/or information enabling identification of a product in an image. Database 146 may include inventory level information for a product generally available with all merchants corresponding to merchant server 140 and/or each specific merchant, as previously discussed. Database 146 may include information about distributors, including preferred distributors and/or distributor inventory level information. Database 146 may include information about user purchase orders, including completed purchase orders for use in updating inventory level information.

In various embodiments, merchant server 140 includes at least one network interface component 148 adapted to communicate with network 170 including user device 110, distributor server 150, and/or payment provider server 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Distributor server 150 may be maintained, for example, by one or more distributors offering products to merchants for sale at merchant locations. Distributor server 150 may correspond generally to a distributor offering inventory to merchant server 140. In this regard, distributor server 150 may include processing applications, which may be configured to interact with user device 110, distributor server 140, and/or payment provider server 160 over network 170 to provide distributor inventory levels and product inventory ordering.

Distributor server 150 includes a product distribution application 152, a database 154, and a network interface component 156. Product distribution application 152 may correspond to processes, procedures, and/or applications executable by a hardware processor, for example, a software program. In other embodiments, distributor server 150 may include additional or different software as required.

In certain embodiments, product distribution application 152 may correspond to processes and/or procedures to provide distributor inventory level information for a product available with distributor server 150. Thus, product distribution application 152 may include an application interface and/or API enabling at least one of user device 110, merchant server 140, and/or payment provider server 160 to access distributor server 150 and check inventory levels for a product available with distributor server 150. Product distribution application 152 may track distributor inventory level information for the product available with distributor server 150 by updating records of incoming product inventory from a manufacturer or other sources and outgoing product inventory levels to merchants (e.g., merchants corresponding to merchant server 140). Product distribution application 152 may provide the distributor inventory level information to user device 110, merchant server 140, and/or payment provider server 160. Additionally, product distribution application 152 may provide for product ordering and reordering to a merchant location. For example, user 102 may request additional product inventory if the merchant location does not possess sufficient inventory levels. Product distribution application 152 may provide inventory ordering to the merchant location based on incoming requests. In other embodiments, the merchant location and/or merchant server 140 may request additional product inventory based on inventory levels at the merchant location.

Distributor server 150 includes database 154, which may include product inventory level information available with distributors corresponding to distributor server 150. Database 154 may include product information, such as product identifiers, prices, manufacturer details, etc. Database 154 may include manufacturer information enabling ordering or product inventory from a manufacturer. Database 154 may further include invoices and other ordering information from merchant server 140 for products available with distributor server 150.

In various embodiments, distributor server 150 includes at least one network interface component 156 adapted to communicate with network 170 including user device 110, merchant server 140, and/or payment provider server 160. In various embodiments, network interface component 156 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 160 may be maintained, for example, by an online payment service provider, which may provide payment services and/or processing for financial transactions on behalf of user 102. In this regard, payment provider server 160 includes one or more processing applications which may be configured to interact with user device 110, merchant server 140, and/or distributor server 150 to facilitate payment for a transaction. Additionally, payment provider server 160 may include applications to track invoices of a merchant and determine preferred distributors for the merchant. Payment provider server 160 may further determine and/or provide information for similar products based on purchase requests by users ordering with a merchant location. In one example, payment provider server 160 may be provided by PAYPAL®, Inc. of San Jose, Calif., USA. However, in other embodiments, payment provider server 160 may be maintained by or include a credit provider, financial services provider, financial data provider, and/or other service provider, which may provide payment services to user 102. Although payment provider server 160 is shown as separate from merchant server 140 and distributor server 150, it is understood the processes, functions, and/or services provided by payment provider server 160 may be incorporated within one or more of merchant server 140 and/or distributor server 150.

Payment provider server 160 of FIG. 1 includes a transaction processing application 162, other applications 164, database 156, and a network interface component 168. Transaction processing application 162 and other application 164 may correspond to processes, procedures, and/or applications executable by a hardware processor, for example, a software program. In other embodiments, payment provider server 160 may include additional or different software as required.

Transaction processing application 162 may be configured to receive and/or transmit information from user device 110, merchant server 140, and/or distributor server 150 for processing and completion of financial transactions. Transaction processing application 162 may include one or more applications to process financial transaction information from user device 110, merchant server 140, and/or distributor server 150 by receiving a request to complete a sale transaction for products available at a merchant location corresponding to merchant server 140. The request may correspond to a payment from user device 110 to the merchant and/or merchant server 140. The payment may include a user account identifier (e.g., a payment account for user 102 with payment provider server 160) or other payment information (e.g. a credit/debit card or checking account). Additionally, the payment may include a payment amount and terms of payment. Transaction processing application 162 may complete the transaction by providing payment to the merchant and/or merchant server 140. Additionally, transaction processing application 162 may provide transaction histories, including receipts, to user device 110 and/or merchant server 140 for completion and documentation of the financial transaction. In a similar manner, transaction processing application 162 may provide payment processes to complete ordering and reordering of product inventory between a merchant/merchant server 140 and distributor server 150. Thus, transaction processing application 162 may receive an invoice for product inventory ordering from one or more or merchant server 140 and distributor server 150 and complete payment for the invoice to distributor server 150 from merchant server 140.

In various embodiments, transaction processing application 162 may retain information of inventory level information with a merchant and/or merchant server 140 for transmission to user device 110. For example, transaction processing application 162 may receive information of inventory levels with the merchant/merchant server 140 or may process invoices corresponding to inventory levels. Thus, ordering invoices from the merchant/merchant server 140 may be utilized to determine an inventory level with the merchant. Thus, transaction processing application 162 may retain the information of the inventory level information.

Transaction processing application 162 may further process inventory cheeks, purchase orders, and/or invoices to provide additional information to one or more of user device 110, merchant server 140, and/or distributor server 150. For example, transaction processing application 162 may update merchant server 140 with available product inventory level information after receiving an inventory check and/or purchase request from user device 110. Additionally, transaction processing application 162 may determine preferred distributors of merchant server 140 through invoices from merchant server 140 and/or distributor server 150, through postage paid by merchant server 140 and distributor server 150, and/or through customer invoices for additional inventory amounts from distributor server 150 to a merchant corresponding to merchant server 140. Transaction processing application 162 may determine similar products to a product by processing user purchase requests for a different product after the user performs an inventory check on a product. For example, payment provider server 160 may receive a purchase request for a product from a user where the user has previously performed an inventory check on another product. In other embodiments, transaction processing application 162 may view products purchased together or as replacements (e.g., when inventory levels of one product do not meet a user's requirements and inventory of another product is purchased to satisfy the requirement) as similar products.

Payment provider server 160 includes other applications 164 as may be desired in particular embodiments to provide features to payment provider server 160. For example, other applications 164 may include security applications for implementing server-side security features, programmatic server applications for interfacing with appropriate application programming interfaces (APIs) over network 170, or other types of applications. Other applications 164 may contain software programs, such as a graphical user interface (GUI), executable by a processor that is configured to provide an interface to a user. Other applications 164 may include user account applications, including user account services, financial accounting services, and/or financial statement services. Where not provided by merchant server 140, other applications 164 may include check-in applications enabling user device 110 to be checked-in with a merchant location and/or merchant server 140. Check-in may be completed through a wireless beacon available at a merchant location, a merchant device at the merchant location, and/or payment provider server 160.

Additionally, payment provider server 160 includes database 166. As previously discussed, user 102, merchant server 140, and/or distributor server 150 may establish one or more user accounts with payment provider server 160. User accounts in database 166 may include user information, such as name, address, birthdate, payment/funding information, additional user financial information, and/or other desired user data. User 102, merchant server 140, and/or distributor server 150 may link user accounts in database 156 through an identifier. Thus, when the identifier is transmitted to payment provider server 160 (e.g., from user device 110, merchant server 140, and/or distributor server 150) a user account may be found. More generally, user accounts in database 166 may correspond to an account established and maintained for engaging in online transactions. However, in other embodiments, user 102, merchant server 140, and/or distributor server 150 may not have previously established a user account. Thus, payment provider server 160 may complete a transaction based on another user financial account received from user device 110, merchant server 140, and/or distributor server 150.

In various embodiments, payment provider server 160 includes at least one network interface component 168 adapted to communicate with user device 110, merchant server 140, and/or distributor server 150 over network 170. In various embodiments, network interface component 168 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

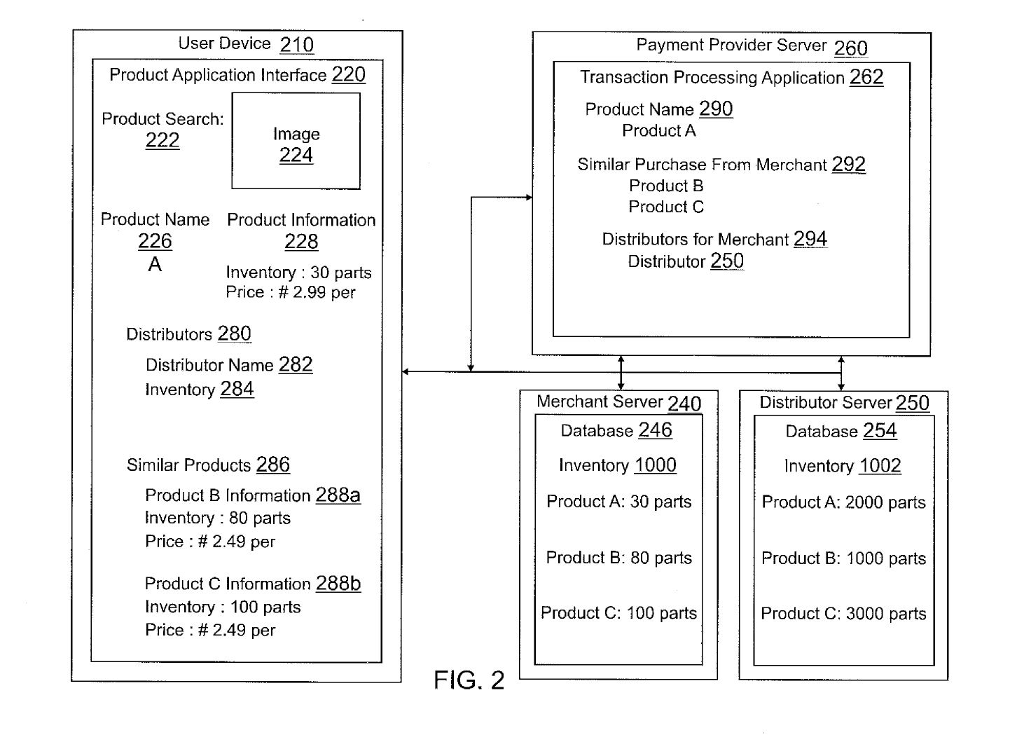

FIG. 2 is an exemplary interaction between a user device and a plurality of servers for displaying product inventory level information to a user, according to an embodiment. FIG. 2 includes a user device 210, a merchant server 240, a distributor server 250, and a payment provider server 260 corresponding generally to user device 110, merchant server 140, distributor server 150, and payment provider server 160, respectively, of FIG. 1.

User device 210 of FIG. 2 is shown with a product application interface 220 corresponding generally to the described processes and features of product application 120 of FIG. 1. Product application interface 220 displays a product search 222, an image 224, a product name 226, and product information 228. A user (not shown) may utilize user device 210 to capture an image including a product, as previously discussed, while at a merchant location (not shown). The image may be loaded and product application interface 220 may display product search 222 having image 224. If the user selects to search image 224 for the product, image analysis may be performed on image 224 to recognize the product. Once image recognition is performed on the image and the product is recognized in the image, product application interface 220 may display product name 226 and product information 228 to the user. Product name 226 include name A, while product information 228 include an inventory level of 30 parts and a price of $2.99 per unit, Product information 228 may be retrieved from merchant server 240 for display to the user. Merchant server 240 is shown with database 246 including inventory 1000 having product A: 30 parts. Database 246 may further include information on other products, such as product B: 80 parts, and product C: 100 parts.

The user of user device 210 may determine that the inventory level shown in product information 228 is insufficient for the required level of the user. Thus, product application interface 220 may further receive information from distributor server 250 corresponding to distributor inventory level information of an available inventory level of the product. Distributor server 250 is shown with database 254 having inventory 1002. Inventory 1002 includes information for available product levels of product A, as well as other products available with the merchant corresponding to merchant server 240 (i.e., product B and product C). The available inventory level with distributor server 250 and distributor information may be displayed to the user at distributors 280. Distributors 280 may include all distributors for the product, distributors associated with the merchant, and/or preferred distributors of the merchant. Preferred distributors may be determined from input by a merchant and/or system administrator corresponding to merchant server 240. However, in other embodiments, transaction processing application 262 may process invoices between merchant server 240 and distributor server 250, postage paid for delivery of items, communications, etc. between a merchant for merchant server 240 and a distributor for distributor server 250, and/or customer inventory requests for delivery to a merchant for merchant server 240 and a distributor for distributor server 250. Transaction processing application 262 may therefore show distributors for merchant 294 having distributor 250. Transaction processing application may provide this information for preferred distributors in distributors 280. The name of the distributor or information enabling an order request may be displayed as distributor name 282. Moreover the available inventory numbers (e.g., product A: 2000 parts, product B: 1000 parts, and product C: 3000 parts) may be displayed in product application interface 220 as inventory 284.

In various embodiments, the user of user device 210 may determine the inventory for product A available with the merchant and displayed in product information 228 is insufficient to meet the requirements of the user. Thus, the user may request to view similar products to product A. Merchant server 240 and/or payment provider server 260 may determine similar products from merchant/user input (e.g., identification of similar products), from product information (e.g., similar metadata, images, or product specifications), or from purchase requests by users after viewing a product. As previously discussed, a user may make a purchase of a different product after viewing inventory levels for product A and determining the inventory levels do not meet the requirements of the user. Thus, the user may purchase product B or product C after viewing and not purchasing product A because of a lack of inventory. Transaction processing application 262 on payment provider server 260 may process these purchase requests to determine the similar items. Transaction processing application 262 therefore contains product name 290 and similar purchase from merchant 292. Using product name 290 for product A, transaction processing application 262 may retrieve similar purchases from merchant 292 having product B and product C. Thus, product B and product C may be communicated to user device 210.

The user of user device 210 may view similar products 286 containing information of similar products received from payment provider server 260 and/or merchant server 240. Similar products 286 include product B information 288a and product C information 288b. Product B information 288a includes inventory 80 parts and price $2.49 per part. Product C information 288b includes inventory 100 parts and $2.49 per part. Thus, the user of the user device may make a purchase of product B or product C if the inventory levels meet the required amount for the user.

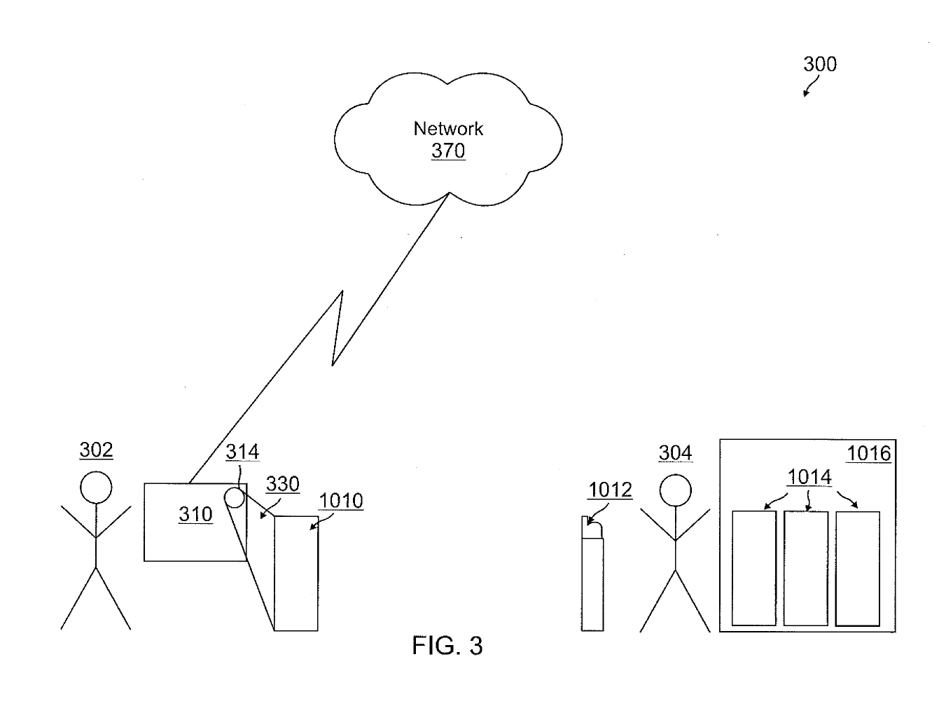

FIG. 3 is an exemplary system environment showing a user retrieving product inventory level information from a merchant, according to an embodiment. Merchant location 300 includes a user 302, a user device 310, and a network 370 corresponding generally to user 102, user device 110, and network 170, respectively, of FIG. 1.

User 302 may visit merchant location 300 with user device 310. User device 310 includes a camera 314 corresponding generally to camera 114 of FIG. 1. User 302 may utilize camera 314 to capture image 330 of product 1010. Image 330 may then be processed to determine product 1010. As previously discussed, user device 310 may process the image to recognize product 1010 or the image may be transmitted to another entity to process the image. For example, user device 310 may transmit the image to merchant device 1012 either directly or over network 370. Once the product is recognized, the product recognition (e.g., product name/information/identifier) may be used by a merchant server available over network 370 or by merchant device 1012 to check storeroom 1016 for inventory 1014.

For example, a merchant server may be utilized to keep inventory stock for inventory 1014, where the merchant server is available over network 370. However, in other embodiments, merchant location 300 may keep track of inventory 1014 using merchant device 1012. Thus, user device 310 may communicate directly or over network 370 with merchant device 1014 to retrieve available inventory 1014 in stockroom 1016. Thus, user 302 is not required to ask a salesperson 304 to check stockroom 1016 for inventory 1014. Instead, inventory 1014 may be transmitted to user device 310 for display to user 302.

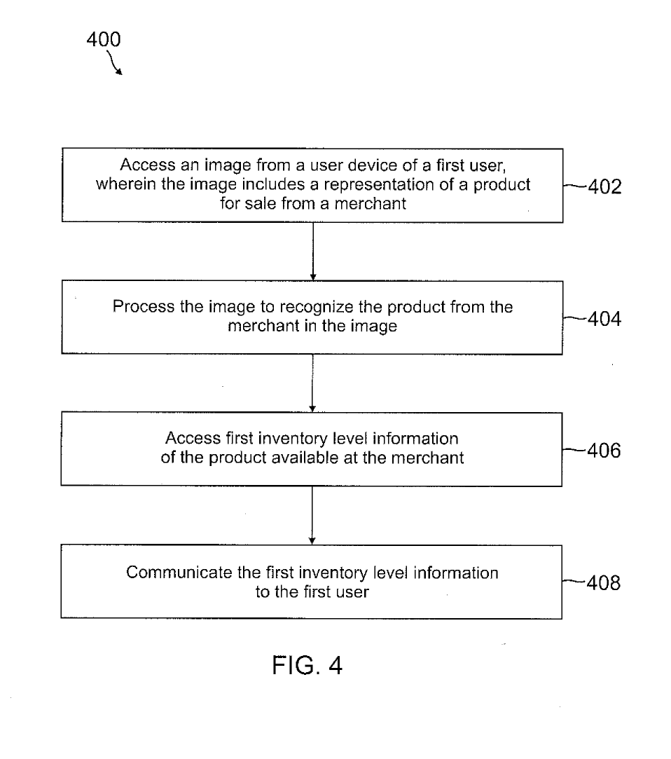

FIG. 4 is a flowchart of an exemplary process for automatic product information at a merchant location, according to an embodiment. Note that one or more steps, processes, and methods described herein may be omitted, performed in a different sequence, or combined as desired or appropriate.

At step 402, an image from a user device of a first user is accessed, wherein the image includes a representation of a product for sale from a merchant. The image may be captured by the user device and held by the user device or transmitted to another source for image analysis. Thus, the image may be accessed by accessing a database storing the image, receiving the image from a user device, and/or receiving the image from a point of sale device or wireless beacon at the merchant. At step 404, the image is processed to recognize the product from the merchant in the image. Image analysis/recognition may be utilized with product information to recognize the product in the image.

First inventory level information of the product available at the merchant is accessed, at step 406. First inventory level information may comprise an available inventory level for the product with the merchant. Additionally, distributor inventory level information for the product from at least one distributor corresponding to the merchant may be accessed. At step 408, the first inventory level information is communicated to the first user. The distributor inventory level information may also be communicated to the first user.

Preferred distributors of the merchant may be determined using at least one of invoices of the merchant, postage paid by the merchant, and customer invoices with the merchant. The distributor inventory level information may be determined for the preferred distributors and stored for later user by the first user or the merchant. Thus, the first user or the merchant may retrieve distributor inventory level information for the preferred merchants even if one of the preferred distributors is unavailable.

A purchase request or inventory check may be received from the first user or a sales representative at the merchant, wherein the purchase request comprises a request to determine if a number of units of the product are available with the merchant. Based on the purchase request, the first inventory level information of the product with the merchant is decreased by the number of units. Conversely, information corresponding to a delivery of an inventory amount of the product to the merchant by a distributor may be received. Thus, the first inventory level information of the product may be increased by the inventory amount.

In certain embodiments, at least one similar product corresponding to the product may be determined, wherein the at least one similar product is purchased by a second user if the product is unavailable with the merchant. Second inventory level information for the at least one similar product may be determined with the merchant. Thus, the second inventory level information may be communicated to the first user.

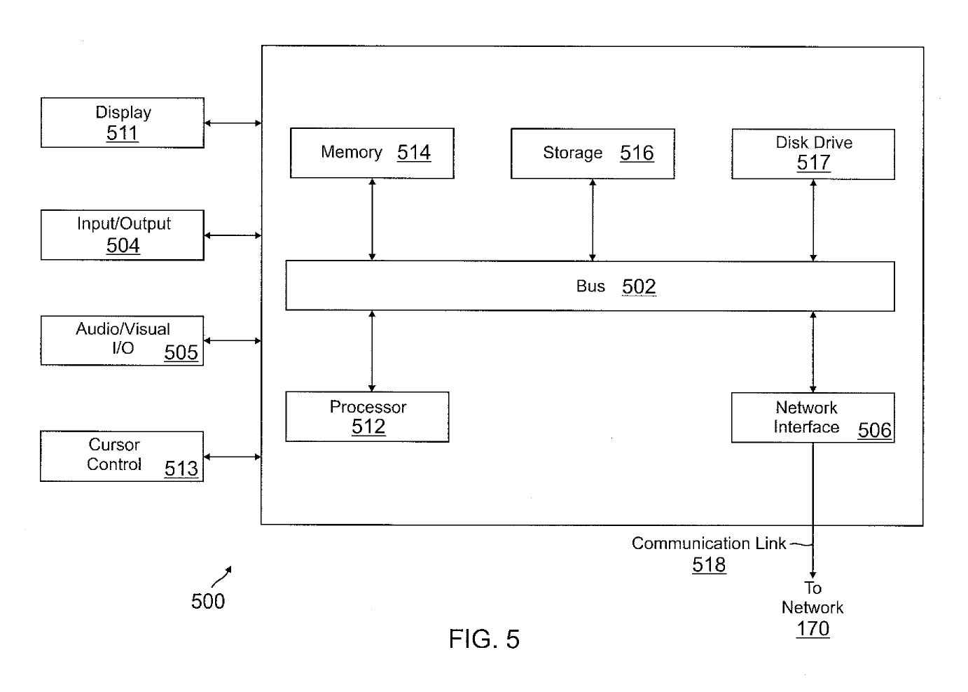

FIG. 5 is a block diagram of a computer system 500 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing product information comprising first sales information for a product with a merchant; and
one or more hardware processors in communication with the non-transitory memory and configured to:
access an image from a user device of a first user, wherein the image includes a representation of the product for sale from the merchant;
process the image to recognize the product from the merchant in the image;
access first inventory level information of the product available at the merchant; and
communicate the first inventory level information to the first user.

2. The system of claim 1, wherein the one or more hardware processors is further configured to:
determine distributor inventory level information for the product from at least one distributor corresponding to the merchant; and
communicate the distributor inventory level information to the first user.

3. The system of claim 1, wherein the one or more hardware processors is further configured to:
determine preferred distributors of the merchant using at least one of invoices of the merchant, postage paid by the merchant, and customer invoices with the merchant.

4. The system of claim 3, wherein the one or more hardware processors is further configured to:
determine distributor inventory level information for the product from each of the preferred distributors; and
store the distributor inventory level information for use by the first user or the merchant.

5. The system of claim 1, wherein the one or more hardware processors is further configured to:
receive a purchase request or inventory check from the first user or a sales representative at the merchant, wherein the purchase request or inventory check comprises a request to determine if a number of units of the product is available with the merchant; and
decrease the first inventory level information of the product with the merchant by the number of units.

6. The system of claim 5, wherein the one or more hardware processors is further configured to:
receive information corresponding to a delivery of an inventory amount of the product to the merchant by a distributor;
increase the first inventory level information of the product with the merchant by the inventory amount.

7. The system of claim 6, wherein the information comprises at least one of a payment by the merchant to the distributor, an invoice by the distributor to the merchant, and an inventory update by the merchant.

8. The system of claim 1, wherein the one or more hardware processors is further configured to:
determine at least one similar product corresponding to the product, wherein the at least one similar product is purchased by a second user if the product is unavailable with the merchant;
determine second inventory level information for the at least one similar product from the merchant; and
communicate the second inventory level information to the first user.

9. The system of claim 1, wherein the one or more hardware processors is further configured to access the image by one of accessing a database storing the image, receiving the image from a user device, and receiving the image from a point of sale or wireless beacon at the merchant.

10. A method comprising:
accessing an image from a user device of a first user, wherein the image includes a representation of a product for sale from a merchant;
processing, using one or more hardware processors, the image to recognize the product from the merchant in the image
accessing first inventory level information of the product available at the merchant; and
communicating the first inventory level information to the first user.

11. The method of claim 10 further comprising:
determining distributor inventory level information for the product from at least one distributor corresponding to the merchant; and
communicating the distributor inventory level information to the first user.

12. The method of claim 10 further comprising:
determining preferred distributors of the merchant using at least one of invoices of the merchant, postage paid by the merchant, and customer invoices with the merchant.

13. The method of claim 12 further comprising:
determining distributor inventory level information for the product from each of the preferred distributors; and
storing the distributor inventory level information for use by the first user or the merchant.

14. The method of claim 10 further comprising:
receiving a purchase request or inventory check from the first user or a sales representative at the merchant, wherein the purchase request or inventory check comprises a request to determine if a number of units of the product is available with the merchant; and
decreasing the first inventory level information of the product with the merchant by the number of units.

15. The method of claim 14 further comprising:
receiving information corresponding to a delivery of an inventory amount of the product to the merchant by a distributor;
increasing the first inventory level information of the product with the merchant by the inventory amount.

16. The method of claim 15, wherein the information comprises at least one of a payment by the merchant to the distributor, an invoice by the distributor to the merchant, and an inventory update by the merchant.

17. The method of claim 10 further comprising:
determining at least one similar product corresponding to the product, wherein the at least one similar product is purchased by a second user if the product is unavailable with the merchant;
determining second sales information for the at least one similar product from the merchant; and
communicating the second sales information to the first user.

18. The method of claim 10, wherein the accessing the image comprises one of accessing a database storing the image, receiving the image from a user device, and receiving the image from a point of sale or wireless beacon at the merchant.

19. A non-transitory computer readable medium comprising a plurality of machine-readable instructions which when executed by one or more processors of a server are adapted to cause the server to perform a method comprising:
accessing an image from a user device of a first user, wherein the image includes a representation of a product for sale from a merchant;
processing the image to recognize the product from the merchant in the image;
accessing inventory level information of the product available at the merchant; and
communicating the inventory level information to the first user.

20. The non-transitory computer readable medium of claim 19, wherein the method further comprises:
determining distributor inventory level information for the product from at least one distributor corresponding to the merchant; and
communicating the distributor inventory level information to the first user.
